(19) United States
(12) Patent Application Publication
(10) Pub. No.: US 2002/0135184 A1
(43) Pub. Date: Sep. 26, 2002

(54) Mechanical pipe coupling derived from a standard fitting

(76) Inventors: Ronald R. Snyder SR., Schnecksville, PA (US); Charles E. Wilk JR., Northampton, PA (US); Lawrence W. Thau JR., Flemington, NJ (US); Douglas R. Dole, Whitehouse Station, NJ (US)

Correspondence Address: John A. Chionchio, Esquire, Synnestvedt & Lechner LLP, Suite 2600, 1101 Market Street, Philadelphia, PA, 19107-2950, US

(21) Appl. No.: 10/007,951

(22) Filed: Dec. 3, 2001

Related U.S. Application Data
(60) Provisional application No. 60/262,820, filed on Jan. 19, 2001.

(51) Int. Cl. F16L 37/08

(52) U.S. Cl. 285/340; 285/321; 285/369

(57) ABSTRACT

A coupling for joining pipe segments together is disclosed. The coupling is derived from a standard fitting and has a housing with a socket and a first expanded region adjacent to the socket and a second expanded region adjacent to the first expanded region. A sealing member is positioned in the first expanded region and a retainer is positioned in the second expanded region. A flange turned inwardly on the second expanded region captures the sealing member and the retainer. The retainer has a plurality of radial teeth angularly oriented to engage a pipe and prevent its removal from the coupling. Each tooth has a stiffening rib arranged lengthwise along the tooth.

### RELATED APPLICATION

This application is based on and claims priority of U.S. Provisional Application No. 60/262,820, filed Jan. 19, 2001.

### FIELD OF THE INVENTION

This invention relates to couplings for pipes and especially to mechanical couplings derived from standard fittings which effect a strong, reliable joint with a fluid-tight seal without the need for brazing or soldering.

### BACKGROUND OF THE INVENTION

The construction of piping networks requires couplings that can form fluid-tight joints between pipe ends which can withstand external mechanical forces, as well as internal fluid pressure and reliably maintain the integrity of the joint. Many forms of joints are known, such as brazed or soldered joints, threaded joints, welded joints and joints effected by mechanical means.

For example, copper tubing, which is used extensively throughout the world to provide water service in homes, businesses and industry, is typically joined by means of couplings which are soldered to the pipe ends to effect a connection.

The use of copper tubing for piping networks is so widespread that standard tubing sizes have been established in various countries. For example, in the U.S., there is the ASTM Standard; in Germany, the DIN Standard; and in the United Kingdom, the British Standard (BS). Chart 1 below shows a portion of the range of outer diameters of the various standard copper tubes listed above.

CHART 1
Standard Outer Copper Tube Outer Diameters

| ASTM | DIN | BS |
|---|---|---|
| ½″ | 15 mm | 15 mm |
| ¾″ | 22 mm | 22 mm |
| 1″ | 28 mm | 28 mm |
| 1.25″ | 35 mm | 35 mm |
| 1.5″ | 42 mm | 42 mm |
| 2″ | 54 mm | 54 mm |

Naturally, there are standard pipe fittings such as elbows (45° and 90°), tees and straight segments matched for use with the standard tube diameters. These standard fittings are defined in the U.S. by ASME Standard B16.22a-1998, Addenda to ASME B16.22-1995 entitled “Wrought Copper and Copper Alloy Solder Joint Pressure Fittings” dated 1998. The standard fittings have open ends with inner diameters sized to accept the outer diameter of a particular standard tube in mating contact for effecting a soldered joint.

In addition to the standard fittings described above, other components, such as valves, strainers, adapters, flow measurement devices and other components which may be found in a pipe network, will have a coupling which is compatible with the standard pipe, and it is understood that the term “coupling”, when used herein, is not limited to a standard elbow, tee or other fitting but includes the open end of any component useable in a piping network which serves to couple the component to the pipe end.

A soldered joint is effected between a standard diameter tube end and its associated standard fitting by first cleaning the surfaces to be joined, typically with an abrasive such as a wire brush or steel wool, to remove any contaminants and the oxide layer which forms on the surfaces. Next, the cleaned surfaces are coated with a flux material, usually an acid flux, which further disrupts the oxide layer (when heated) and permits metal to metal contact between the fitting, the pipe end and the solder. The pipe end is next mated with the fitting thereby bringing the cleaned, flux coated surfaces into contact. The fitting and pipe end are then heated to the melting temperature of the solder, and the solder is applied to the interface between the tube and the fitting. The solder melts, flows between the surfaces of the pipe end and the fitting via capillary action and upon cooling and solidifying forms the solder joint. Excess flux is removed from the outer surfaces to prevent further acid etching of the joint.

While the soldered joint provides a strong, fluid-tight connection between pipe end and fitting, it has several disadvantages. Many steps are required to make the soldered joint, thus, it is a time consuming and labor intensive operation. Some skill is required to obtain a quality, fluid-tight joint. Furthermore, the solder often contains lead, and the flux, when heated, can give off noxious fumes, thus, exposing the worker to hazardous substances which can adversely affect health over time. The joint is typically heated with an open gas flame which can pose a fire hazard.

To overcome these disadvantages, many attempts have been made to create mechanical couplings which do not require solder or flame to effect a strong, fluid-tight joint. Such mechanical couplings often use an over-sized opening accommodating an O-ring for sealing purposes and an annular retainer interposed between the outer diameter of the pipe end and the inner diameter of the coupling to mechanically hold the parts together. The retainer often has radially extending teeth which dig into the facing surfaces of the coupling and the pipe end to resist extraction of the pipe end from the coupling after engagement.

While these mechanical couplings avoid the above identified problems associated with soldered joints, they can suffer from one or more of the following disadvantages. To be effective, the retainer requires sufficient space within the coupling. Thus, the couplings tend to be oversized relatively to the pipes they are intended to receive, and if existing standard couplings are to be adapted for use with such a mechanical system, it is usually necessary to adapt a larger size standard fitting to a smaller size standard pipe. This is more expensive than adapting the standard fitting appropriate to the standard pipe in what is known as a “size-on-size” fitting. For example, a standard ¾ inch pipe fitting may be used to couple a ½ inch standard copper pipe in a mechanical system (not “size-on-size”). Furthermore, the retainer may not provide adequate pull-out strength, and the pipe end could be inadvertently separated from the coupling, for example, during a pressure spike within the pipe, caused by a sudden closing of a valve (the “water hammer effect”) which places the joint under tension.

The retainer also does not help keep the pipe end concentric with the coupling upon insertion, allowing the pipe end to tip and deform the retainer and gouge the inside surface of the coupling or an elastomeric seal, such as an O-ring. In such a mechanical joint, there is furthermore little or no resistance to axial rotation of the pipe relatively to the coupling (i.e., relative rotation of the pipe and coupling about the longitudinal axis of the pipe). Thus, valves or other items mounted on the pipe will tend to rotate. Mechanical joints with retainers also tend to have little resistance to bending, allowing the pipe too much angular free play and permitting the pipe to “walk” out of the joint under repeated reversed bending loads. Excessive free play also tends to disengage the teeth on one side of the retainer and deform the teeth on the other side, weakening the joint. Furthermore, use of an enlarged section to accommodate the retainer may cause energy loss impeding fluid flow if the fluid is forced to flow into a coupling having a larger cross-sectional area. In general, when mechanical couplings are designed to overcome the aforementioned inherent disadvantages, they tend to suffer from a high part count, making them relatively complex and expensive.

There is clearly a need for a mechanical pipe coupling which avoids the disadvantages of both soldered pipe fittings, as well as prior art mechanical fittings described above, and which can be derived from existing standard fittings and used with pipes appropriate to the standard fitting in a “size-on-size” association rather than using a larger size fitting to couple smaller diameter pipes together.

### SUMMARY AND OBJECTS OF THE INVENTION

The invention concerns a pipe coupling having a socket with a diameter sized according to a standard to receive a pipe end having a diameter also sized according to the standard to be compatible with the socket. Preferably, the standard is ASME Standard B16.22a-1998, although other standards, such as the British Standard and the German DIN standard, are also contemplated.

The pipe coupling preferably comprises a stop surface positioned adjacent to one end of the socket, the stop surface extending radially inwardly and being engageable with the pipe end to prevent the pipe end from passing through the pipe coupling. A first expanded region is positioned adjacent to another end of the socket, the first expanded region having a larger diameter than the socket and sized to receive a sealing member, such as an O-ring positionable therein for effecting a seal between the pipe coupling and the pipe end. A shoulder is positioned between the socket and the first expanded region, the shoulder being engageable with the sealing member when it is positioned in the first expanded region.

A second expanded region is positioned adjacent to the first expanded region, the second expanded region preferably having a larger diameter than the first expanded region and sized to receive a retainer positionable therein for retaining the pipe end within the pipe coupling. The second expanded region forms an open end of the pipe coupling for receiving the pipe end. A flange is positioned at the open end and extends substantially radially inwardly to be engageable with the retainer when it is positioned in the second expanded region. The shoulder and the flange capture the sealing member and the retainer between themselves. The flange has an inwardly facing edge with a diameter substantially equal to the socket diameter and coaxial therewith. The inwardly facing edge is circumferentially engageable with the pipe end upon insertion of the pipe into the pipe coupling. The pipe end is supportable by the socket and the inwardly facing edge of the flange. The two-point support, thus, formed provides substantial resistance to bending of the pipe within the coupling.

Preferably, the retainer adapted to interfit within the opening of the pipe coupling comprises a ring sized to circumferentially engage the bore and a plurality of flexible, resilient, elongated teeth arranged circumferentially around the ring. The teeth project substantially radially inwardly from the ring and are angularly oriented in a direction away from the opening. Each of the teeth has a surface with a stiffening rib thereon oriented substantially lengthwise along the teeth. The teeth are engageable circumferentially with the pipe end for preventing movement of the pipe end outwardly from the bore.

The invention also concerns a method of making a pipe coupling by modifying a standard pipe fitting. The pipe coupling is adapted to receive and sealingly engage a standard pipe end sized to engage the standard pipe fitting. The method comprises the steps of:

(1) providing the standard pipe fitting, the standard pipe fitting having a socket with an open end, the socket having a standard diameter sized to coaxially receive the standard pipe end;

(2) expanding a first portion of the socket, positioned in spaced relation to the open end, to a first diameter larger than the socket diameter thereby forming a shoulder between the socket and the open end;

(3) expanding a second portion of the socket, positioned between the first portion and the open end, to a second diameter larger than the first diameter;

(4) inserting a sealing member into the first portion, the sealing member interfitting coaxially within the first portion and engaging the shoulder, the sealing member being engageable circumferentially with the pipe end and the first expanded region for effecting a seal between the pipe coupling and the pipe;

(5) inserting a retainer within the second expanded region, the retainer preferably comprising a ring sized to circumferentially engage the second portion and a plurality of flexible, resilient, elongated teeth arranged circumferentially around the ring, the teeth projecting substantially radially inwardly from the ring and being angularly oriented toward the socket, the teeth being engageable circumferentially with the pipe end for retaining the pipe end within the pipe coupling; and

(6) forming a flange by deforming a portion of the second expanded region to extend substantially radially inwardly at the open end, the sealing member and the retainer being captured between the shoulder and the flange, the flange having an inner edge having a diameter substantially equal to the socket diameter and coaxial therewith, the inner edge being circumferentially engageable with the pipe end upon insertion of the pipe into the pipe coupling, the pipe end being supportable by the socket and the flange edge.

It is an object of the invention to provide a mechanical pipe coupling which does not need to be soldered, brazed, welded, threaded or adhesively bonded to effect a joint.

It is another object of the invention to provide a standard mechanical pipe coupling which can be derived from existing standard pipe fittings.

It is still another object of the invention to provide a standard mechanical pipe coupling which can be used in a “size-on-size” association with an appropriate standard pipe for increased economy, improved fluid flow and compactness.

It is again another object of the invention to provide a standard mechanical pipe coupling which has substantial resistance to bending preventing excessive free play between pipe and coupling.

It is yet another object of the invention to provide a standard pipe coupling providing substantial resistance to axial rotation to prevent rotation of valves and other components about the longitudinal axis of the pipe.

These and other objects and advantages of the invention will become apparent upon consideration of the following drawings and detailed description of preferred embodiments of the invention.

### BRIEF DESCRIPTION OF THE DRAWINGS

FIG. 1 is a partial longitudinal cross-sectional view of a pipe coupling housing according to the invention;

FIG. 2 is a longitudinal cross-sectional view of a pipe coupling according to the invention;

FIG. 3 is a front perspective view of an embodiment of a retainer according to the invention;

FIG. 4 is a rear perspective view of the retainer shown in FIG. 3;

FIG. 5 is a cross-sectional view taken along lines 5-5 of FIG. 3;

FIG. 6 is a front perspective view of another embodiment of a retainer according to the invention;

FIG. 7 is a longitudinal sectional view of yet another embodiment of a retainer according to the invention; and

FIG. 8 is an exploded view of a pipe coupling in the form of an elbow fitting according to the invention.

### DETAILED DESCRIPTION OF THE PREFERRED EMBODIMENT

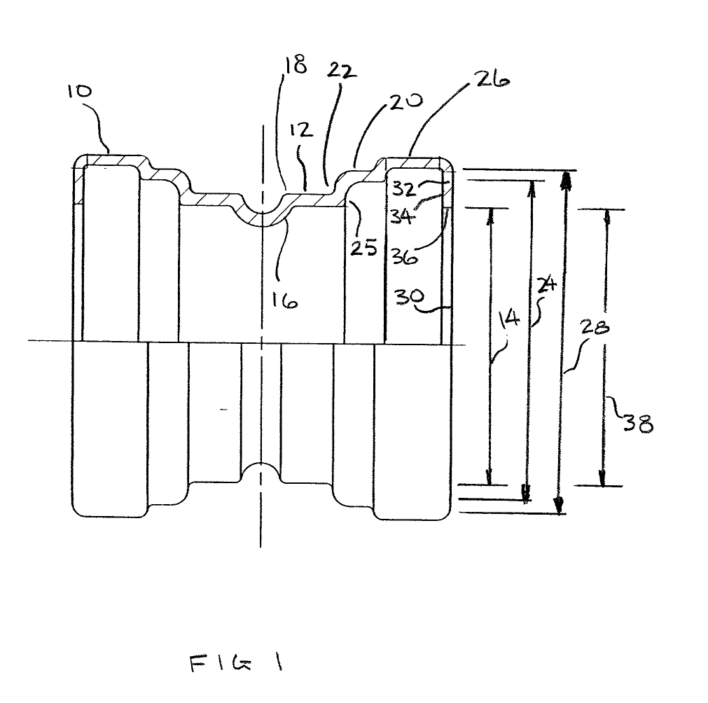

FIG. 1 shows a pipe coupling housing 10 according to the invention having a socket 12 with an inner diameter 14 sized according to a standard to receive a pipe end sized, according to a compatible standard, to interfit within the socket 12. Preferably, coupling housing 10 is a modification of an existing standard pipe fitting, for example, an ASME Standard pipe fitting according to Standard number B16.22a-1998 for wrought copper and copper alloy solder joint pressure fittings. Fittings meeting the specification of other standards, such as the German DIN standard and the British BS standard, may also be modified to derive the coupling housing 10.

A stop surface 16 is positioned adjacent to one end 18 of the socket 12. Stop surface 16 extends radially inwardly and is, thus, engageable with an end of a pipe received within the socket to prevent the pipe end from passing through the coupling housing.

A first expanded region 20 is positioned at the other end 22 of the socket 12, the first expanded region having a larger inner diameter 24 than the socket inner diameter 14. A shoulder 25 is positioned between the socket 12 and the first expanded region 20. The diameter 24 of the first expanded region is sized to receive a sealing member, the sealing member being engageable with the shoulder as described below.

A second expanded region 26 is positioned adjacent to the first expanded region 20. Preferably, second expanded region 26 has a larger inner diameter 28 than the inner diameter 24 of the first expanded region 20 and is sized to receive a retainer, also described below. Second expanded region 26 forms an open end 30 for receiving a pipe end.

A flange 32 is positioned at the open end 30. The flange extends radially inwardly from the second expanded region 26 and has a back face 34 engageable with the aforementioned retainer to capture and hold the retainer within the coupling housing 10. The flange 32 also has an inwardly facing edge 36 having an inner diameter 38 substantially equal to the inner diameter 14 of the socket 12. Together, the socket 12 and flange edge 36 engage and support a pipe end when it is inserted into the coupling housing, the flange edge and socket providing a “two-point” support over a substantial length of the coupling housing. This two-point point support afforded by the flange edge and socket provides substantial resistance to bending of a pipe within the coupling, reduces free play of the pipe, prevents the sealing member and retainer from being damaged by the pipe and ensures a more reliable coupling which is less likely to leak.

Preferably, pipe coupling housing 10 is derived by die forming the socket of an existing standard pipe fitting to create the expanded regions 20 and 26, the flange 32 being turned inwardly in a later operation after internal components such as the aforementioned sealing member and retainer are inserted into the coupling housing 10 to form a coupling according to the invention described in detail below.

While any standard fitting may be used as a starting point, the invention is particularly advantageously used with the ASME standard fittings compatible with copper tubing having a nominal diameter between ½ and 2 inches. Similarly, the German and British standard fittings for copper tubing between 15 mm and 54 mm are also favored. It is understood that the invention is not limited for use with copper tube and could be applied to plastic or steel pipes and fittings for example. While it is advantageous to begin with a standard fitting from an economic standpoint, the coupling housing 10 could also be custom made for a particular application.

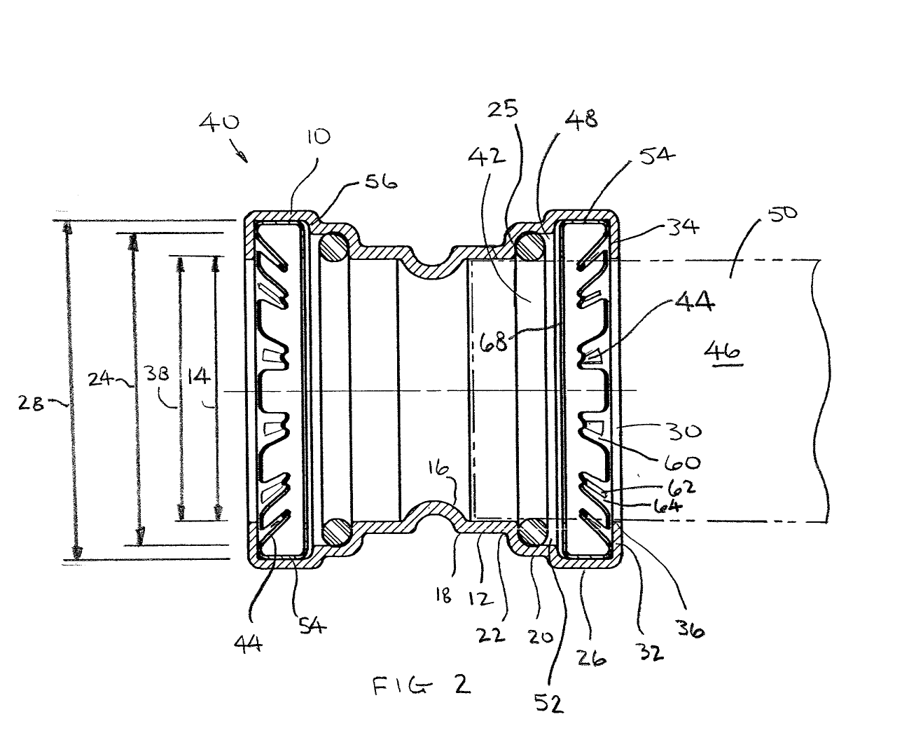

FIG. 2 shows a pipe coupling 40 according to the invention assembled from its various components including pipe coupling housing 10, a sealing member 42 and a retainer 44. A pipe end 46 is shown in phantom line received within the coupling 40. Pipe end 46 is preferably a standard pipe, compatible with ASME Standard BlG.22a-1998, for example, and the coupling housing 10 is preferably formed from a fitting originally designed according to the same standard to receive the pipe end 46 and modified by the formation of the expanded regions 20 and 26 and the flange 32.

To realize economic advantage, it is preferable to modify a standard fitting intended originally for use with the diameter of the pipe end 46 and achieve a “size-on-size” relationship between the coupling and the pipe end. Size-on-size refers to the fact that the fitting being modified is for the size of pipe being coupled and not a fitting intended for a larger sized pipe which is then modified into a coupling which can take a smaller sized pipe.

Sealing member 42 is preferably an elastomeric seal such as an O-ring. A fluid-tight seal is effected between the coupling housing 10 and the pipe end 46 by compressing the sealing member in the annular space 48 between the outer surface 50 of pipe end 46 and the inside surface 52 of the first expanded region 20. Sealing member 42 seats against shoulder 25 which prevents it from moving deeper into the coupling housing 10 when pipe end 46 is inserted through opening 30 to engage the sealing member and be received in socket 12.

As shown in FIG. 2, the inner diameter 14 of socket 12 is sized to receive and support the pipe end 46. Stop surface 16 engages pipe end 46 to position it properly within coupling 40 and prevent it from passing through the coupling housing 10. Further support is provided to pipe end 46 by the inwardly facing edge 36 of flange 32. The inner diameter 38 of the edge 36 is substantially equal to diameter 14 of socket 12 and thus allows the edge 36 to engage the pipe end and provide the two point support which increases the bending stiffness of the joint formed by the coupling 40 and reduces free play of the pipe end within it.

Increased bending stiffness and reduced free play help to ensure a reliable fluid-tight joint between the coupling 40 and the pipe end 46 which will not leak or come apart under repeated bending loads. Furthermore, the increased joint stiffness allows the same hanger spacing as a soldered joint system.

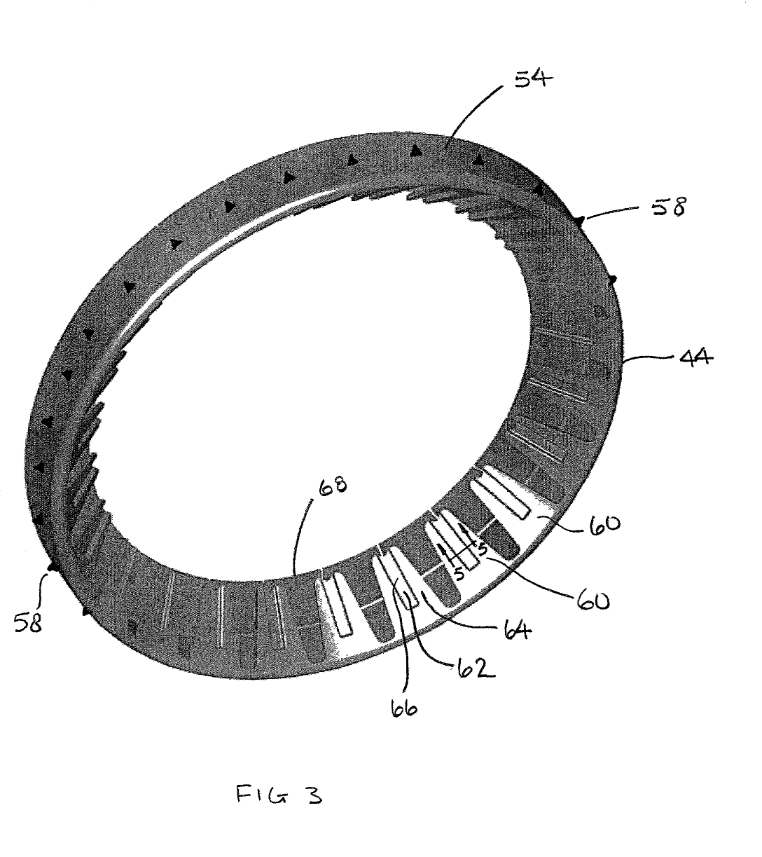

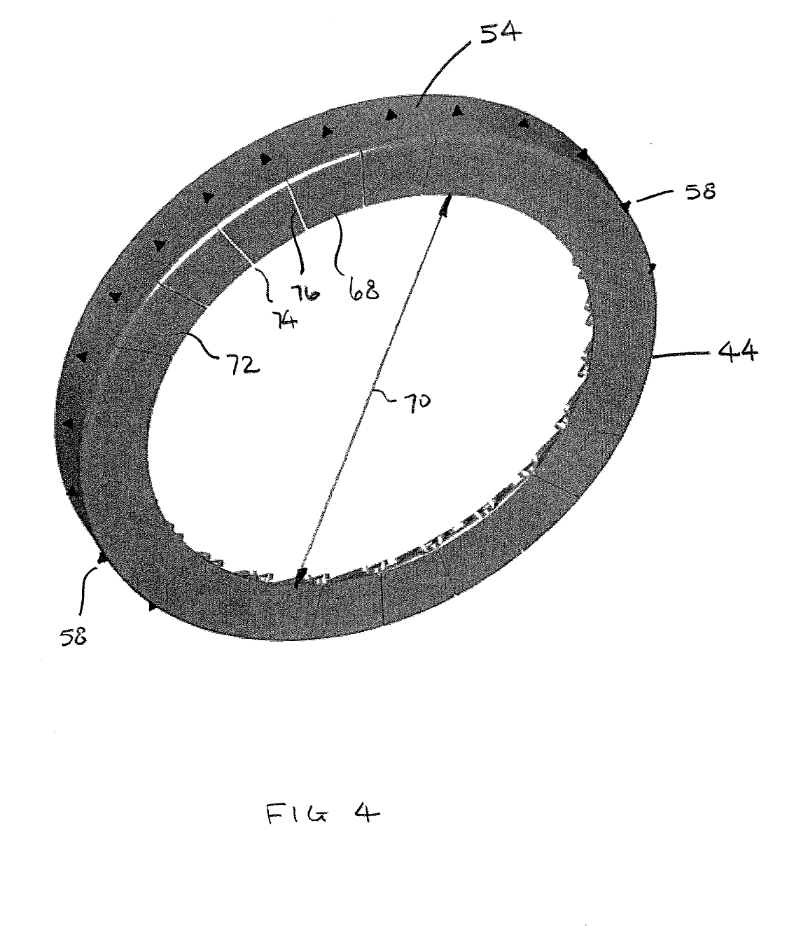

Retainer 44 is shown in detail in FIGS. 3 and 4 and comprises a ring 54 sized to engage the second expanded region 26 of coupling housing 10 (see FIG. 2). The ring seats within region 26 and stabilizes the retainer within the coupling housing. Preferably, coupling housing 10 has a second shoulder 56 which engages the ring 54 to properly position retainer 44 and prevent it from moving deeper into the coupling housing 10. In the absence of shoulder 56, the retainer 44 seats against the sealing member 42. The flange back face 34 also engages the retainer and captures it and the sealing member 42 between itself and the first shoulder 25.

As shown in FIGS. 3 and 4, ring 54 preferably has projections 58 extending radially outwardly. Projections 58 engage the second expanded region 26 and inhibit relative rotation between the retainer 44 and the coupling housing 10. This, in turn, serves to inhibit rotation of the pipe end 46 relative to the coupling 44 about the longitudinal axis of the pipe. Thus, valves or other items mounted on the pipe will be less likely to rotate into an inconvenient or inaccessible position where they become difficult or impossible to actuate.

Retainer 44 has a plurality of flexible, resilient teeth 60 which are arranged circumferentially around the ring 54 and extend substantially radially inwardly thereof. Teeth 60 are angularly oriented in a direction away from opening 30 (see FIG. 2) and are resiliently biased to engage outer surface 50 of pipe end 46. The angular orientation of teeth 60 allows the pipe end 46 to be received within opening 30 and pass through the retainer 44 and the sealing member 42 into socket 12 and seat against stop surface 16 but prevent withdrawal of the pipe end 46 outwardly from the coupling. Outward motion of the pipe end will tend to simultaneously compress and rotate the teeth inwardly thereby causing them to dig into the pipe outer surface 50 and retain the pipe within the coupling in a self-jamming manner such that, as greater force is applied to withdraw the pipe from the coupling the teeth 60 dig further and exert proportionally greater force to resist the outward motion until they bend or buckle.

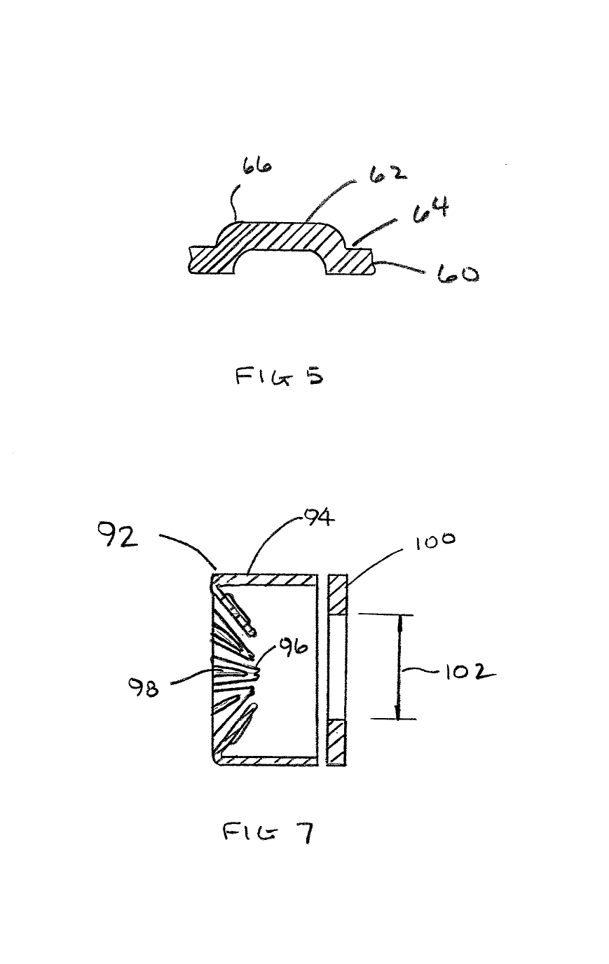

To stiffen the teeth and prevent them from failing in bending or buckling when compressed, stiffening ribs 62 are positioned on the tooth surface 64 and oriented lengthwise along the tooth. Preferably, as shown in FIG. 5, the stiffening ribs comprise a raised section 66 embossed onto tooth surface 64. The raised section increases the area moment of inertia of the tooth and thereby increases the critical load at which the tooth will buckle, as well as the bending strength of the tooth.

Preferably, retainer 44 also comprises a lip 68 (see FIG. 4) which is arranged circumferentially around the retainer and extends substantially radially inwardly from ring 54. As shown in FIG. 2, lip 68 is positioned on the ring in spaced relation to teeth 60 and at least faces or may even engage the sealing member 42. Lip 68 helps capture and retain the sealing member 42 within the first expanded region 20 against fluid pressure and may also be used to increase the sealing force of elastomeric type sealing members, such as the O-ring shown, by providing additional compressive force on the O-ring. As best shown in FIG. 4, lip 68 preferably has an inner diameter 70 substantially equal to the socket diameter 14 and further acts to center pipe end 46 within coupling 40 as it is inserted into the coupling. The lip thus configured helps protect sealing member 42 from being gouged by the pipe end 46 as it passes into socket 12.

Retainer 44 may be manufactured by several different methods. When it is made by drawing a flat sheet, it is advantageous to form lip 68 from a plurality of radial segments 72 arranged circumferentially around ring 54 as shown in FIG. 4. Radial segments 72 are defined by relief slits 74 positioned between each radial segment. The relief slits are cut into the blank used to form the retainer as a plurality of pie or wedge shaped cutouts so that when the segments 72 are bent to form the lip 68 the edges 76 of each adjacent segment will abut one another giving the appearance of a substantially continuous lip around the retainer. Without the relief slits 74, the material used to form the lip will tend to wrinkle as it is bent radially inwardly. By forming lip 68 from multiple segments 72, manufacturing advantages are realized.

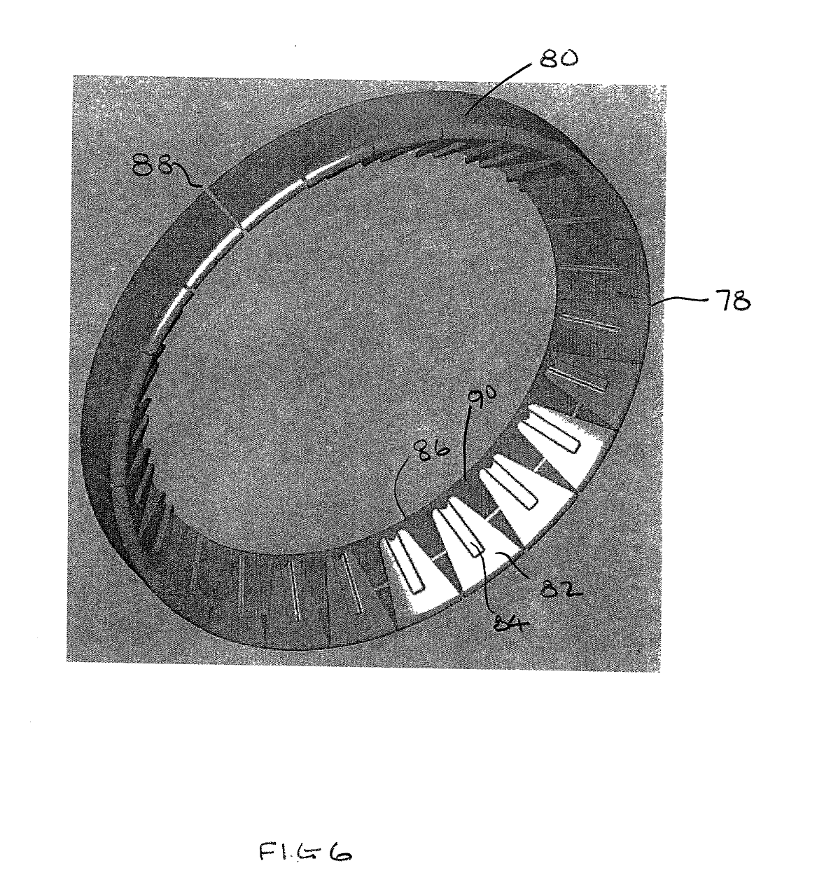

An alternative split retainer 78 is shown in FIG. 6. Similar to retainer 44, split retainer 78 comprises a ring 80 having teeth 82, arranged circumferentially and angularly as described above and preferably having stiffening ribs 84. A lip 86 extends radially inwardly from the ring in spaced relation to teeth 82. Unlike retainer 44, however, the ring 80 and lip 86 have a gap 88, preferably located between two teeth which splits the retainer. The gap 88 allows the retainer to be formed by rolling techniques and the lip 86 can thus be formed as a substantially continuous surface 90 except for gap 88. A substantially continuous lip 86 is stiffer and will be better able to resist pressure loadings and help keep sealing member 42 seated within first expanded region 20.

Another retainer embodiment 92 is shown in FIG. 7 and comprises a ring 94 having radially arrayed teeth 96 with stiffening ribs 98. Retainer 92 does not have an integrally formed lip but instead uses a washer 100 positioned coaxially with ring 94 in spaced relation to teeth 96 and having an inner diameter 102 sized appropriately to receive a pipe end when retainer 92 is positioned within a second expanded region 26 of a coupling housing 10 of the type shown in FIG. 1.

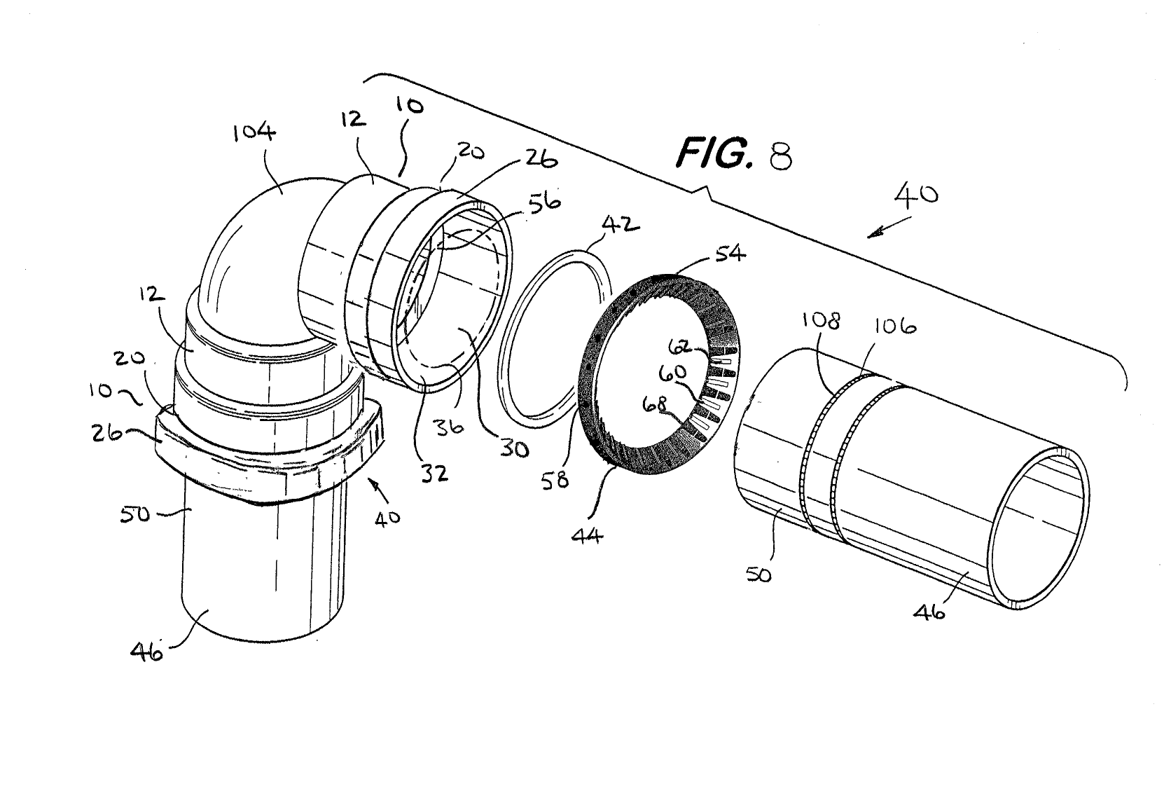

FIG. 8 shows an elbow 104 comprising a pipe coupling 40 according to the invention. As noted above, in addition to the straight through and elbow type couplings illustrated, any type fitting, such as a tee fitting, a fitting forming part of a valve, a sprinkler head or any other mechanical component, may be adapted to use a coupling according to the invention.

FIG. 8 presents an exploded view which is useful to describe how a coupling according to the invention is manufactured and used. Preferably, elbow 104 begins as a standard fitting, for example, a standard ASME wrought copper or copper alloy solder joint pressure fitting according to ASME Standard B16.22a-1998 having a socket 12 sized to receive pipe end 46. Portions of the socket 12 are expanded, preferably by die-forming, into a first and a second expanded region 20 and 26. Next, sealing member 42 is positioned within the first expanded region 20 and retainer 44 is then positioned adjacent to the sealing member in the second expanded region 26. Note that other retainer embodiments, such as the split retainer 78 illustrated in FIG. 6 as well as the two part retainer 92 and washer 100 may also be used. After the components are inserted and properly seated within the expanded regions, the flange 32 is formed by turning a portion of the second expanded region 26 radially inwardly to capture the sealing member 42 and retainer 44 and form opening 30 defined by the inwardly facing edge 36 of flange 32 (shown in phantom line).

Coupling 40 thus formed is ready to receive a pipe end 46 in sealing engagement. Pipe end 46 may have grooves 106 cut or cold-formed in its outer surface 50 to engage teeth 60 of retainer 44 and provide additional gripping force preventing inadvertent separation of the pipe end from the fitting 104. The grooves 106 may have knurling 108 or be otherwise textured to engage teeth 60 and prevent or at least inhibit rotation of the pipe end relative to the retainer. As described above, retainer 44 has projections 58 (see FIGS. 3 and 4) extending outwardly from its ring 54 to prevent or inhibit rotation of the retainer relative to the coupling housing 10. Together, knurling 108, teeth 60 and projections 58 help prevent rotation of the pipe end 46 about its long axis relative to the fitting 104.

Couplings according to the invention provide a mechanical pipe coupling which can form a reliable fluid tight joint without the hazards associated with brazing, welding or soldering while taking advantage of existing standard fittings in a size-on-size relationship with standard pipe to achieve significant economical advantage.

What is claimed is:

1. A pipe coupling housing having a socket with a diameter sized according to a standard to receive a pipe end having a diameter sized to be compatible with said socket, said pipe coupling housing comprising:
a first expanded region positioned adjacent to one end of said socket, said first expanded region having a larger diameter than said socket and sized to receive a sealing member positionable therein for effecting a seal between said pipe coupling housing and said pipe end, a shoulder being positioned between said socket and said first expanded region, said shoulder being engageable with said sealing member when positioned in said first expanded region;
a second expanded region positioned adjacent to said first expanded region and sized to receive a retainer positionable therein for retaining said pipe end within said pipe coupling housing, said second expanded region forming an open end of said pipe coupling housing for receiving said pipe end; and
a flange positioned at said open end and extending substantially radially inwardly to be engageable with said retainer when positioned in said second expanded region, said shoulder and said flange being adapted to capture said sealing member and said retainer therebetween, said flange having an inwardly facing edge having a diameter substantially equal to said socket diameter and coaxial therewith, said inwardly facing edge being circumferentially engageable with said pipe end upon insertion of said pipe into said pipe coupling housing, said pipe end being supportable by said socket and said inwardly facing edge of said flange.

2. A pipe coupling housing according to claim 1, wherein said second expanded region has a larger diameter than said first expanded region.

3. A pipe coupling housing according to claim 1, further comprising a stop surface positioned adjacent to another end of said socket opposite said one end, said stop surface extending radially inwardly and being engageable with said pipe end to prevent said pipe end from passing through said pipe coupling housing.

4. A pipe coupling housing according to claim 2, wherein said standard is ASME Standard B16.22a-1998.

5. A pipe coupling housing according to claim 4, wherein said ASME Standard is for fittings compatible with copper tubing having a nominal diameter between ½ inch and 2 inches inclusive.

6. A pipe coupling housing according to claim 2, wherein said standard is a German DIN standard.

7. A pipe coupling housing according to claim 6, wherein said DIN Standard is for fittings compatible with copper tubing having a diameter between 15 mm and 54 mm inclusive.

8. A pipe coupling housing according to claim 2, wherein said standard is a British Standard.

9. A pipe coupling housing according to claim 8, wherein said British Standard is for fittings compatible with copper tubing having a diameter between 15 mm and 54 mm inclusive.

10. A pipe coupling housing according to claim 2, wherein said coupling housing comprises an elbow fitting.

11. A pipe coupling housing according to claim 2, wherein said coupling housing comprises a straight fitting.

12. A pipe coupling sealingly engageable with a pipe end, said pipe coupling comprising:
a coupling housing having a socket with a diameter sized to receive and circumferentially support said pipe end;
a first expanded region positioned adjacent to one end of said socket, said first expanded region having a larger diameter than said socket and a shoulder positioned between said socket and said first expanded region;
a sealing member positioned in said first expanded region to effect a seal between said pipe coupling and said pipe end, said sealing member being engaged with said shoulder;
a second expanded region positioned adjacent to said first expanded region, said second expanded region forming an open end of said pipe coupling for receiving said pipe end;
a retainer interfitting in said second expanded region and being engageable circumferentially with said pipe end for retaining said pipe end within said pipe coupling; and
a flange positioned at said open end and extending substantially radially inwardly, said retainer engaging said flange, said sealing member and said retainer being captured between said shoulder and said flange, said flange having an inwardly facing edge having a diameter substantially equal to said socket diameter and coaxial therewith, said inwardly facing edge being circumferentially engageable with said pipe end upon insertion of said pipe into said pipe coupling, said pipe end being supportable by said socket and said inwardly facing edge of said flange.

13. A pipe coupling according to claim 12, wherein said second expanded region has a larger diameter than said first expanded region.

14. A pipe coupling according to claim 12, further comprising a stop surface positioned adjacent to another end of said socket opposite said one end, said stop surface extending radially inwardly and being engageable with said pipe end to prevent said pipe end from passing through said coupling housing.

15. A pipe coupling according to claim 13, wherein said socket has a diameter sized according to a standard to receive said pipe end, said pipe end also having a diameter sized to be compatible with said socket.

16. A pipe coupling according to claim 15, wherein said standard is ASME Standard B16.22a-1998.

17. A pipe coupling according to claim 16, wherein said ASME Standard is for fittings compatible with copper tubing having a nominal diameter between ½ inch and 2 inches inclusive.

18. A pipe coupling according to claim 15, wherein said standard is a German DIN standard.

19. A pipe coupling according to claim 18, wherein said DIN Standard is for fittings compatible with copper tubing having a diameter between 15 mm and 54 mm inclusive.

20. A pipe coupling according to claim 15, wherein said standard is a British Standard.

21. A pipe coupling according to claim 20, wherein said British Standard is for fittings compatible with copper tubing having a diameter between 15 mm and 54 mm inclusive.

22. A pipe coupling according to claim 13, wherein said coupling comprises an elbow fitting.

23. A pipe coupling according to claim 13, wherein said coupling comprises a straight fitting.

24. A pipe coupling according to claim 13, wherein said sealing member comprises an elastomeric ring sized to be compressible between said second expanded region and said pipe end thereby effecting said seal.

25. A pipe coupling according to claim 13, wherein said retainer comprises:
a ring sized to circumferentially engage said second expanded region; and
a plurality of flexible, resilient, elongated teeth arranged circumferentially around said ring, said teeth projecting substantially radially inwardly from said ring and being angularly oriented toward said socket, said teeth being engageable circumferentially with said pipe end for retaining said pipe end within said pipe coupling.

26. A coupling according to claim 25, further comprising a plurality of projections extending substantially radially outwardly from said ring, said projections engaging said second expanded region for inhibiting relative rotational motion between said retainer and said coupling.

27. A coupling according to claim 25, wherein each of said teeth has a surface with a stiffening rib thereon oriented substantially lengthwise along said tooth.

28. A pipe coupling according to claim 27, wherein said stiffening ribs comprise a raised section embossed onto said surface of said teeth.

29. A pipe coupling according to claim 27, wherein said ring is split.

30. A pipe coupling according to claim 29, wherein said ring is split at a point located between two adjacent teeth.

31. A pipe coupling according to claim 25, wherein said retainer further comprises a lip extending substantially radially inwardly from said ring in spaced relation to said teeth, said lip having an inner diameter substantially equal to said socket diameter and engageable with said pipe end.

32. A pipe coupling according to claim 31, wherein said lip comprises a plurality of radial segments arranged circumferentially around said ring, each of said segments having a pair of substantially radially aligned edges.

33. A pipe coupling according to claim 25, wherein said teeth have a predetermined length so as to interfit within a groove formed circumferentially around said pipe end when said pipe end engages said socket, said teeth being engageable with said groove to increase resistance to movement of said pipe outwardly from said coupling.

34. A pipe coupling housing having a socket with a diameter sized to receive a pipe end having a diameter sized to be compatible with said socket, said pipe coupling housing comprising:
a first expanded region positioned adjacent to one end of said socket, said first expanded region having a larger diameter than said socket and sized to receive a sealing member positionable therein for effecting a seal between said pipe coupling housing and said pipe end, a shoulder being positioned between said socket and said first expanded region, said shoulder being engageable with said sealing member when positioned in said first expanded region;
a second expanded region positioned adjacent to said first expanded region and sized to receive a retainer positionable therein for retaining said pipe end within said pipe coupling housing, said second expanded region forming an open end of said pipe coupling housing for receiving said pipe end; and
a flange positioned at said open end and extending substantially radially inwardly to be engageable with said retainer when positioned in said second expanded region, said shoulder and said flange being adapted to capture said sealing member and said retainer therebetween, said flange having an inwardly facing edge having a diameter substantially equal to said socket diameter and coaxial therewith, said inwardly facing edge being circumferentially engageable with said pipe end upon insertion of said pipe into said pipe coupling housing, said pipe end being supportable by said socket and said inwardly facing edge of said flange.

35. A pipe coupling housing according to claim 34, wherein said second expanded region has a larger diameter than said first expanded region.

36. A pipe coupling housing according to claim 34, further comprising a stop surface positioned adjacent to another end of said socket opposite said one end, said stop surface extending radially inwardly and being engageable with said pipe end to prevent said pipe end from passing through said pipe coupling housing.

37. A method of making a pipe coupling by modifying a standard pipe fitting, said pipe coupling being adapted to receive and sealingly engage a standard pipe end sized to engage said standard pipe fitting, said method comprising the steps of:
providing said standard pipe fitting, said standard pipe fitting having a socket with an open end, said socket having a standard diameter sized to coaxially receive said standard pipe end;
expanding a first portion of said socket, positioned in spaced relation to said open end, to a first diameter larger than said socket diameter thereby forming a shoulder between said socket and said open end;
expanding a second portion of said socket, positioned between said first portion and said open end, to a second diameter larger than said first diameter;
inserting a sealing member into said first portion, said sealing member interfitting coaxially within said first portion and engaging said shoulder, said sealing member being engageable circumferentially with said pipe end and said first portion for effecting a seal between said pipe coupling and said pipe;
inserting a retainer within said second portion, said retainer comprising a ring sized to circumferentially engage said second portion and a plurality of flexible, resilient, elongated teeth arranged circumferentially around said ring, said teeth projecting substantially radially inwardly from said ring and being angularly oriented toward said socket, said teeth being engageable circumferentially with said pipe end for retaining said pipe end within said pipe coupling; and
forming a flange by deforming said second portion to extend substantially radially inwardly at said open end, said sealing member and said retainer being captured between said shoulder and said flange, said flange having an inner edge having a diameter substantially equal to said socket diameter and coaxial therewith, said inner edge being circumferentially engageable with said pipe end upon insertion of said pipe into said pipe coupling, said pipe end being supportable by said socket and said flange edge.

38. A method according to claim 37, wherein said step of providing a standard pipe fitting comprises providing a standard pipe fitting which conforms with ASME Standard B16.22a-1998.

39. A method according to claim 38, wherein said step of providing a standard pipe fitting comprises providing a standard pipe fitting which is compatible with standard copper tubing having a nominal diameter between ½ inch and 2 inches inclusive.

40. A retainer adapted to interfit within a bore of a pipe coupling, said retainer being engageable with a pipe end insertable through an opening into said bore for preventing motion of said pipe end outwardly from said bore, said retainer comprising:
a ring sized to circumferentially engage said bore; and
a plurality of flexible, resilient, elongated teeth arranged circumferentially around said ring, said teeth projecting substantially radially inwardly from said ring and being angularly oriented in a direction away from said opening, each of said teeth having a surface with a stiffening rib thereon oriented substantially lengthwise along said teeth, said teeth being engageable circumferentially with said pipe end for preventing movement of said pipe end outwardly from said bore.

41. A retainer according to claim 40, further comprising a plurality of projections extending substantially radially outwardly from said ring, said projections engaging said bore for inhibiting relative rotational motion between said retainer and said pipe coupling.

42. A retainer according to claim 40, wherein said stiffening ribs comprise a raised section embossed onto said surface of said teeth.

43. A retainer according to claim 40, wherein said retainer further comprises a lip extending substantially radially inwardly from said ring in spaced relation to said teeth.

44. A retainer according to claim 43, wherein said ring is split at a point located between two adjacent teeth.

45. A pipe coupling according to claim 44, wherein said ring is split at a point located between two adjacent teeth.

46. A retainer according to claim 43, wherein said lip comprises a plurality of radial segments arranged circumferentially around said ring, each of said segments having a pair of substantially radially aligned edges.
